(19) United States
(12) Patent Application Publication
(10) Pub. No.: US 2003/0182841 A1
(43) Pub. Date: Oct. 2, 2003

(54) Disposable illuminated fishing lure

(76) Inventors: Charles Thomas Calak JR., Lindenhurst, NY (US); Gloria Del Casino, Sayville, NY (US)

Correspondence Address: Charles T. Calak Jr., 108 West Lido Prom, Lindenhurst, NY, 11757, US

(21) Appl. No.: 10/112,334

(22) Filed: Mar. 30, 2002

(51) Int. Cl. A01K 75/02; A01K 85/00

(52) U.S. Cl. 43/17.6

(57) ABSTRACT

A fishing lure utilizing a solid, resin-like body encapsulating electrical circuits, including an internal oscillating microchip, in a translucent bait shaped body. Several light emitting diodes are programmed to blink sequentially in a predetermined pattern, thus illuminating the entire lure body. An externally attached magnet is moved toward an internal reed switch to activate the LED's. The lure is disposable with no requirements for changing encapsulated battery.

### BACKGROUND—FIELD OF INVENTION

This invention relates to illuminated fishing lures. This lure utilizes light emitting diodes (LED's) programmed to flash in a specific sequence. The LED's are encapsulated in the body, allowing the entire body to illuminate, thus increasing the effectiveness of the lure.

### BACKGROUND—DESCRIPTION OF PRIOR ART

Prior art devises are typically clumsy, requiring disassembly to remove the battery in order to turn on and shut off the light source. They can also be dangerous to the operator by requiring the jarring of the device for the battery to make contact with the light source, or by having to take the lure apart and changing or inserting batteries. These devices contain hooks and can be hazardous to handle.

The current devices utilizing LED's as illumination have limited visibility. The LED's are usually placed at the position of the eyes of the device. This makes only a small portion of the device visible when the LED's are activated.

Existing lures do not seem to emulate the lighting effects of natural bait. Typically, bait fish do not have blinking eyes.

### SUMMARY OF THE INVENTION

It is the intent of this invention to provide an improved, disposable, illuminated fishing lure. The lure utilizes encapsulated LED's and power source to illuminate the entire body. It is provided with a magnetic device, which activates a reed switch allowing the LED's to flash in a predetermined sequence. The device body is a resin-like substance, thus protecting the electronics encapsulated within.

### OBJECTS OF THE INVENTION

It is the object of this invention to provide a lure whose entire body is illuminated, thus making it more visible to game fish.

It is a further object of this invention to produce an illuminated fishing lure that is easily used with limited mechanical components.

It is a further object of this invention to produce an illuminated fishing lure with an externally activated switch, thus allowing ease of operation with no assembly or disassembly.

Other objects of this invention will become apparent when it is considered in conjunction with the accompanying drawings.

### DRAWING FIGURES

FIG. 1 is a side elevation view of the present invention.

FIG. 2 is a cross-sectional top view of the present invention.

FIG. 3 is the schematic diagram of the circuitry housed in the lure body of the present invention.

### REFERENCE NUMERALS IN DRAWINGS

1 LED's

2 Battery

3 Resistor

4 Internal oscillating microchip

5 Reed switch

6 Magnet

7 Leader line

8 Metallic barrel swivel

9 Circuit board

10 Molded lure body

11 Eyelet

12 Hook

13 Tail material

### DESCRIPTION OF PREFERRED EMBODIMENT

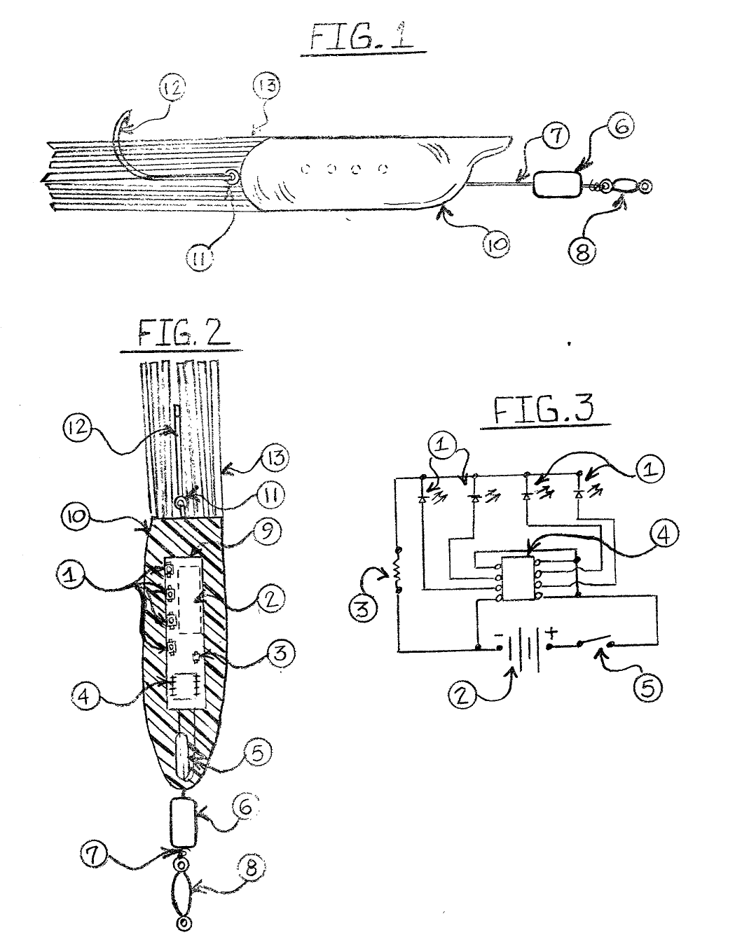

Referring to the figures, in particular FIG. 1 and FIG. 2, the fishing lure which is shown generally is comprised of body 10, generally made of a resin-like translucent material, thus assisting in the illumination of the entire body by the LED's 1. Body 10 is provided with a hook 12 secured to the body 10 by means of an eyelet 11. Additionally attached to the body 10 is leader material 7, a magnet 6, metallic barrel swivel 8 allowing for attachment to fishing line, and tail material 13.

FIG. 2 shows generally the various components housed inside the body 10. It will be understood that FIG. 2 is used by way of illustration only and is not intended to accurately depict electrical connections of the various components that go to make up the power source or used to energize the LED's 1.

When the lure is at rest, magnet 6 is magnetically held away from the reed switch 5 by a metallic barrel swivel 8. To activate, slide magnet 6 towards body 10. This will activate the reed switch 5. When activated, LED's 1 illuminate in a predetermined sequence. As the lure is pulled through the water, resistance against the magnet 6 holds it against the body 10, thus keeping the LED's 1 activated. The LED's 1 remain activated until magnet 6 is moved back in contact with the metallic barrel swivel 8 along the leader material 7 thus opening the reed switch and disabling the circuit.

Referring to FIG. 3, when the reed switch 5 is activated by the magnet 6, completing the circuit of the internal oscillating microchip 4 and battery 2, the internal oscillating microchip 4 sends voltage to the anode side of the LED's 1 in a predetermined sequence. The LED's 1 cathode side are connected to the resistor 3 and the negative side of the battery 2, thus completing each of the individual LED's 1 circuit. The circuit card 9 is a means of connecting the components.

While this invention has been described in conjunction with the preferred embodiment thereof, it is to be understood that the invention is capable of changes or modifications within the scope of the invention concept. Furthermore, since numerous modification and changes will readily occur to those skilled in the art, it is not desired to limit the invention to the exact construction and operation shown and described.

What I claim as being new and desired to be protected by Letters Patent of the Unites States is as follows:

1. A fishing lure comprising a solid-body construction of a predetermined configuration having a plurality of light emitting diodes and a power supply to activate the lights;
a solid body, which illuminates upon activation of the LED's;
a body made of a translucent, resin-like substance to further assist in the illumination;
a plurality of LED's programmed to flash in a predetermined sequence, thus increasing the visibility and effectiveness of the lure;
a magnetic reed switch activated by an externally positioned magnet;
at least one hook secured to said body;
an attachment from said body as a means to affix to fishing lines.
